(19) United States
(12) Patent Application Publication
(10) Pub. No.: US 2012/0143725 A1
(43) Pub. Date: Jun. 7, 2012

(54) METHODS AND SYSTEMS FOR INFLUENCING SEARCH AND SHOPPING DECISIONS IN ELECTRONIC PROCUREMENT

(75) Inventors: John Hutchinson, Cincinnati, OH (US); Venkateswaran Krishnan, Bangalore (IN); Senthilkumar Vadivel, Mason, OH (US)

(73) Assignee: Vinimaya Inc.

(21) Appl. No.: 13/309,069

(22) Filed: Dec. 1, 2011

Related U.S. Application Data
(60) Provisional application No. 61/418,936, filed on Dec. 2, 2010.

(51) Int. Cl. G06Q 30/00

(52) U.S. Cl. 705/26.62

(57) ABSTRACT

Disclosed embodiments relate to an electronic procurement tool that enables the buyer, or purchasing organization, on a near real-time basis, to review or influence the search and purchasing patterns from the supplier(s) catalogs that are enabled through an electronic marketplace using priorities, specified ranks, and promotions. In one aspect, the disclosed systems and methods may allow users to view supplier catalog items that are more relevant to their search criteria and/or that comply with an organization's contract with a supplier. It may also allow users to view popular items in terms of purchase frequency and the average/relevant purchase price or transparently in terms of the preference of the purchasing organization.

### CROSS-REFERENCE TO RELATED APPLICATIONS

The present application claims benefit of provisional application Ser. No. 61/418,936 entitled “Methods and Systems for Influencing Search and Shopping Decisions in Electronic Procurement,” filed on Dec. 2, 2010, which is herein incorporated by reference in its entirety.

### TECHNICAL FIELD

The presently disclosed embodiments relate to electronic procurement tools and, more particularly, to methods and systems for purchasing organizations to review and influence search and purchasing decisions of employees to comply with supplier contracts.

### BACKGROUND

Organizations use electronic procurement systems to allow individuals to order items from supplier's catalogs. In certain circumstances, organizations have contracts with suppliers restricting the purchase of some items and indicating that other items are preferred by the organization. However, individuals ordering items from the supplier's catalog may not know of the contract or its terms. Accordingly, there is a need for systems and methods to assist decisions in electronic procurement.

### Brief Summary

Disclosed embodiments provide computer-based procurement systems that allow search results for catalog items to be influenced by priorities assigned by an administrator or other mechanisms associated with an organization. In one embodiment, a system is provided for influencing a search result in an electronic catalog. In one aspect, the system includes a processor and a memory that includes instructions that cause the processor to perform processes for assisting in the procurement of items. For example, the processor may be configured to search an electronic catalog to generate a plurality of items. The memory may further include instructions that cause the processor to generate information used to display the plurality of items and determine a priority for at least one of the items in the plurality of items. The memory may further include instructions that cause the processor to save the priority for the at least one item.

Also consistent with disclosed embodiments, a computer-implemented method is provided for influencing a search result in an electronic catalog including a processor and a memory. In one aspect, the method may include searching an electronic catalog to generate a plurality of items in a search result. The method may further include retrieving a priority associated with at least one item of the plurality of items and using the priority to remove the item from the search result. The method may further include generating information used to display the search result.

Consistent with other disclosed embodiments, tangible computer-readable storage media may store program instructions that are executable by a processor to implement any of the methods disclosed herein.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various embodiments and exemplary aspects of disclosed embodiments and, together with the description, explain disclosed principles.

In the drawings:

FIG. 1 is a diagram of exemplary system components that may be used to implement disclosed embodiments;

FIG. 2 is a flow diagram illustrating an exemplary item priority setup process, consistent with disclosed embodiments;

FIG. 3 is a flow diagram illustrating an exemplary search results prioritizing process, consistent with disclosed embodiments;

FIG. 4 is a flow diagram illustrating an exemplary purchase report process, consistent with disclosed embodiments;

FIG. 5 is a flow diagram illustrating an exemplary purchase history process, consistent with disclosed embodiments;

FIG. 6 is an exemplary function and component responsibility matrix, consistent with disclosed embodiments;

FIG. 7 is an exemplary search request summary display, consistent with disclosed embodiments;

FIG. 8 is an exemplary search request result display, consistent with disclosed embodiments;

FIG. 9 is an exemplary search review display, consistent with disclosed embodiments;

FIG. 10 is an exemplary search results prioritizing display, consistent with disclosed embodiments;

FIG. 11 is another exemplary search results prioritizing display, consistent with disclosed embodiments;

FIG. 12 is an exemplary search request summary display after prioritizing, consistent with disclosed embodiments;

FIG. 13 is an exemplary search request result display after prioritizing, consistent with disclosed embodiments;

FIG. 14 is an exemplary top purchase summary display, consistent with disclosed embodiments;

FIG. 15 is an exemplary monthly purchase volume, value, and checkout history report for a top purchase, consistent with disclosed embodiments;

FIG. 16 is an exemplary buyer summary display, consistent with disclosed embodiments;

FIG. 17 is an exemplary monthly purchase volume, value, and checkout history report for a top buyer, consistent with disclosed embodiments; and

FIG. 18 is an exemplary custom purchase history report, consistent with disclosed embodiments.

### DESCRIPTION OF THE EMBODIMENTS

Disclosed embodiments include an electronic procurement system that enables a buyer or purchasing organization, on a near real-time basis, to review or influence the search and purchasing patterns from supplier catalogs that are enabled through an electronic marketplace. Disclosed embodiments may use priorities, rank information, such as user specified ranks, and promotions to influence the search and purchasing patterns of individuals in the organization. Such review and influence is enabled regardless of whether content is accessed via local/static catalogs and supplier managed content, via punchout or similar integration technology, or via eCommerce enabled web presence.

Disclosed embodiments allow organizations to influence search and purchasing decisions by generating and displaying search activities performed in the electronic marketplace by one or more users belonging to the buying organization (although authorized users outside the organization may also be allowed to participate and use the system); generating and saving the criteria of searches (e.g., search term, search type, suppliers) launched by end users. The disclosed embodiments may further generate and display search results based on the saved search criteria for a prioritizing process and enable users to assign priorities to individual search result items (supplier catalog items) on a pre-defined scale (e.g., numeric) that indicates the relevance of the search result to the search and/or relevance in terms of buying organizations' contract with the supplier. Moreover, the disclosed embodiments provide mechanism that enable users to assign priorities in bulk to search results or entire supplier catalog items on a pre-defined scale (e.g., numeric) that indicates the relevance of the search result to the search and/or relevance in terms of buying organizations' contract with the supplier, block certain search result items (supplier catalog items) from appearing in subsequent search results, and rank search results (supplier catalog items) on a pre-defined scale. The disclosed embodiments may also generate information for displaying search results such that the items with highest priorities show up at the top followed by items with lower priorities without user intervention for such an ordering. Disclosed embodiments also allow users to view the top purchase/buyer information and to review the purchase history.

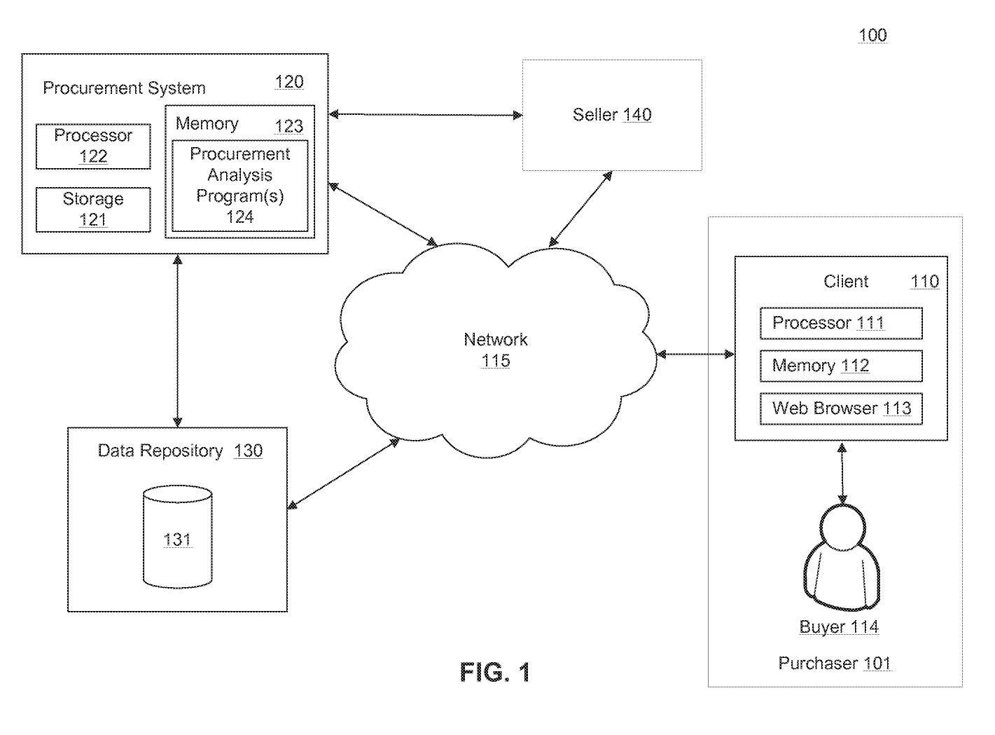

FIG. 1 is a diagram illustrating an exemplary electronic procurement analysis system that may be used to implement disclosed embodiments, including exemplary system components. The components and arrangement, however, may vary.

In one embodiment, procurement system 120 may include a processor 122, a memory 123, input/output (I/O) devices (not shown), and a nonvolatile storage 121. Procurement system 120 may be implemented in various ways. Procurement system 120 may be a general purpose computer, a server, a mainframe computer, or any combination of these components. Procurement system 120 may communicate over a link with network 115. For example, the link may be a direct communication link, a LAN, a WAN, or other suitable connection. Procurement system 120 may be standalone or it may be part of a subsystem, which may, in turn, be part of a larger system, such as a legacy procurement system.

Processor 122 may be one or more known processing devices, such as a microprocessor from the Pentium™ or Xeon™ family manufactured by Intel™ or the Turion™ family manufactured by AMD™. Memory 123 may be one or more storage devices configured to store information used by processor 122 to perform certain functions related to disclosed embodiments. Storage 121 may be a volatile or non-volatile, magnetic, semiconductor, tape, optical, removable, nonremovable, or other type of storage device or tangible computer-readable medium. In one embodiment, memory 123 may include one or more procurement analysis programs or subprograms 124 loaded from storage 121 or elsewhere that, when executed by procurement system 120, or another processor perform various procedures, operations, or processes consistent with disclosed embodiments. For example, memory 123 may include a search history generation program that re-creates a search performed by a user (such as, for example, an individual in an organization), an item priority setup program that creates and saves data used to assign priorities to individual search result items, a search results prioritizing program that applies saved priorities to search results of an electronic catalog, a reporting program that creates reports from the search and priority data, and an integrative support program that links the other programs and allows them to use a common database, provides a common user interface, performs basic bookkeeping tasks, (such as storing the user's input, etc.), and provides user guidance and help. Memory 123 may also include other programs that perform other functions and processes, such as programs that provide communication support, Internet access, etc.

Methods, systems, and articles of manufacture consistent with disclosed embodiments are not limited to separate programs or computers configured to perform dedicated tasks. For example, memory 123 may include a one or more programs 124 that performs procurement analysis functions consistent with certain disclosed embodiments. Moreover, processor 122 may execute one or more programs located remotely from procurement system 120. For example, procurement system 120 may access one or more remote programs that, when executed, perform functions related to disclosed embodiments.

Memory 123 may be also be configured with an operating system (not shown) that performs several functions well known in the art when executed by procurement system 120. By way of example, the operating system may be Microsoft Windows™, Unix™, Linux™, Solaris™, an Apple Computers operating system, Personal Digital Assistant operating system such as Microsoft CE™, or some other operating system. The choice of operating system, and even to the use of an operating system, is not critical to any embodiment.

Procurement system 120 may include one or more I/O devices (not shown) that allow data to be received and/or transmitted by procurement system 120. I/O devices may also include one or more digital and/or analog communication input/output devices that allow procurement system 120 to communicate with other devices. Procurement system 120 may receive data from external devices and output data to external machines and devices via I/O devices. The configuration and number of input and/or output devices incorporated in I/O devices may vary as appropriate for certain embodiments.

Procurement system 120 may also be communicatively connected to one or more data repositories 130 either directly or indirectly, such as through network 115. Data repository 130 may include one or more databases 131 that store information, such as catalogs, prior searches, or usage data, and are accessed and/or managed through procurement system 120. By way of example, the databases may be Oracle™ databases, Sybase™ databases, Microsoft™ SQL Server databases, or other relational databases. The databases may include, for example, data and information related to searches performed, item purchases, supplier contracts, supplier catalogs, catalog item priorities, etc. Systems and methods of disclosed embodiments, however, are not limited to separate databases or even to the use of a database.

Procurement analysis server 120 may be communicatively connected to one or more sellers 140. Seller 140 may be a computer system associated with a seller (or other type of entity) that executes processes through one or more processors. In one embodiment, seller 140 may include a computer system that generates, stores, and maintains information, such as items from the seller's electronic catalog and other information that allows seller to provide information used by other systems or users to display, select, purchase and view items from the seller's electronic catalog.

Client 110 may be a computer system associated with a purchaser 101 that may be an entity that, through computer systems, selects and purchases items from seller 140 (or other entities) electronically, such as on-line or other forms of electronic procurement. Client 110 may include one or more processors 111, a memory 112, and a web browser 113 (or similar software that presents information received over network 115) that enable it to communicate with procurement system 120 and seller 140. Procurement system 120 may send data to client 110, and web browser 113 (or similar software) may display the data. For example, based on data received from procurement system 120 and/or seller 140, web browser 113 may render search results, reports, item priority setup, etc. In some embodiments, procurement system 120 may render the search results, reports, or input screens to web browser 113 for display. In other embodiments, procurement system 120 may send the data used to create a search result list, a report, or an input screen to client 110 and client 110 may render the appropriate display. Client 110 may be used by buyer 114 to purchase items from seller server 140 through procurement system 120.

Buyer 114 may represent one or more users associated with purchaser 101. In other embodiments, a buyer may use a client 110 that is not associated with a purchasing entity (such as purchaser 101). For instance, a user may operate a computer system (not shown) independent of purchaser 101 that interacts with procurement system 120 and/or seller 140 through network 115. Moreover, in other embodiments, client 110 may be a mobile computer system, such as a laptop or mobile smart device (e.g., iPhone™, iPad™, Blackberry™, etc.), that is used by buyer 114 who is remotely located from purchaser 101. For example, buyer 114 may represent a user who works for purchaser 101 and is traveling and is remotely located from his office. Buyer 114, through client 110, may interact with procurement system 120 while remotely located from his office, in a manner consistent with the disclosed embodiments. Buyer 114 may reflect an administrator user that has different access rights compared to other types of users to data and processes implemented by procurement system 120. An administrator may access and interact with administrator type processes following security measures, such as a password, or other forms of identification mechanisms.

Client 110 may send data to procurement system 120 indicating selection of items for purchase, search terms, item priorities, report requests etc. Client 110 may include I/O devices (not shown) to enable communication with an individual. For example, the I/O devices may include one or more input devices, such as a keyboard, touch screen, mouse, and the like, that enable client 110 to receive data from a user, such as search and filter parameters, report requests, purchasing requests, etc. Further, client 110 may include I/O devices that communicate with one or more output devices, such as a display screen, CRT monitor, LCD monitor, plasma display, printer, speaker devices, and the like, that enable client 110 to present data to a user.

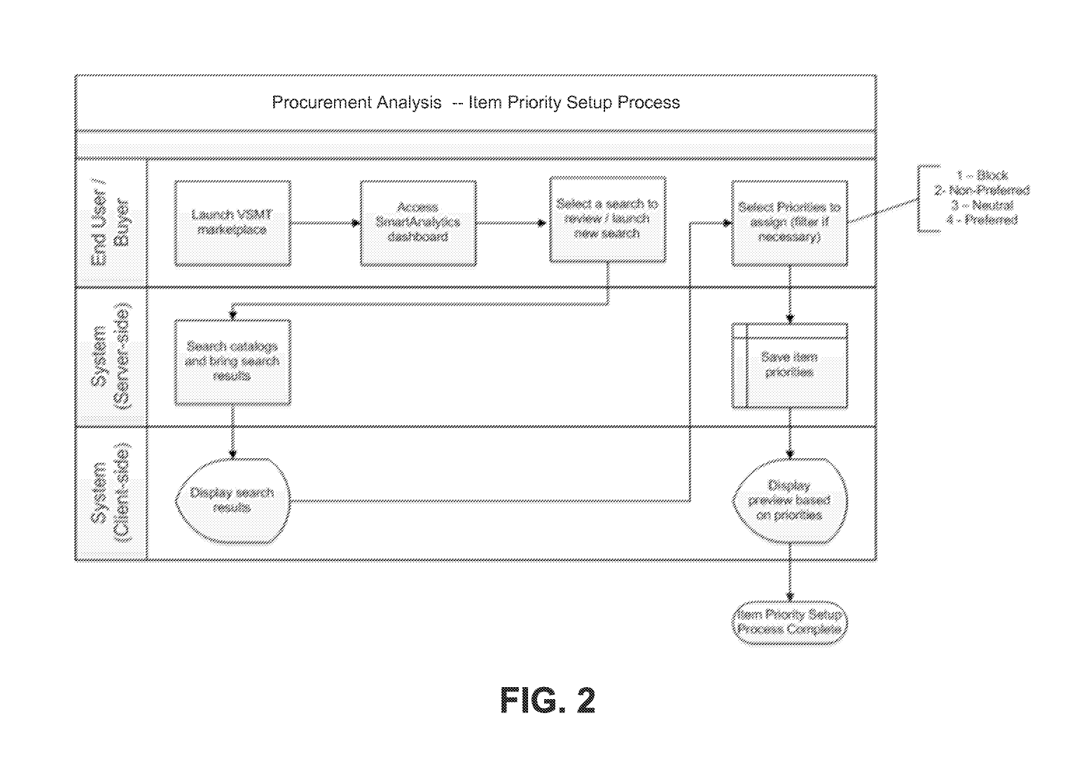

FIG. 2 is a flow diagram illustrating an exemplary item priority setup process, consistent with disclosed embodiments. As shown, and in one example, “End User/Buyer” reflects processes performed by a user (e.g., buyer 114), “System (Server-side)” reflects processes performed by procurement system 120, and “System (client-side)” reflects processes performed by client 110 (e.g., web browser 113).

In one aspect an “end user” may represent that the action is performed by a person using the procurement system. A buyer may refer to a type of end user who may, for example, search and shop for items sold by, for example, seller 140. An administrator may refer to a type of end user who performs configuration, administrative, and other system related functions on behalf of buyers and/or a purchasing organization, such as purchaser 101.

In one embodiment, a user, such as an individual associated with a buying organization (e.g., purchaser 101), can prioritize the search results by reviewing the frequently launched searches or by launching a new search. Certain embodiments enable systems and/or process executed by a processor to analyze searches. The search results can be displayed for prioritizing in a format where the user or computer system can assign priorities from a pre-defined scale such as, for example, numeric values like 1 to 4, 1 being least priority (blocking results) and 4 being highest priority. Other types of values may be implemented for reflecting and assigning priorities.

The procurement system may generate Filters that may be used by a user (e.g. buyer) to narrow the search results down to the set of items of interest in order to set priorities. Filters may be options generated by procurement system 120 and presented on an interface that provides a user with options for narrowing or selecting preference in receiving and reviewing data. Software executed by a processor responds to selection of the filters to generate results that are displayed on a display (or other form of data representation). In one aspect, procurement system 120 may execute software that performs filtering processes that filters search results based on input received by client 110.

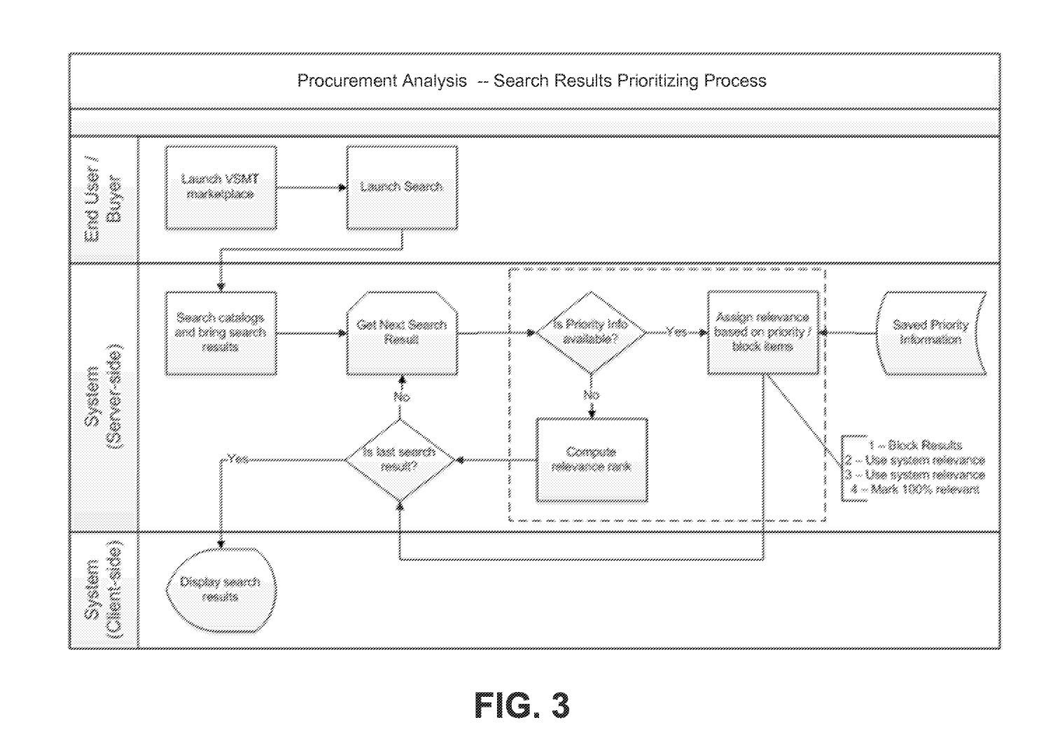

FIG. 3 is a flow diagram illustrating an exemplary search results prioritizing process, consistent with disclosed embodiments. As shown, and in one example, “End User/Buyer” reflects processes performed by a user (e.g., buyer 114), “System (Server-side)” reflects processes performed by procurement system 120, and “System (client-side)” reflects processes performed by client 110 (e.g., web browser 113). Disclosed embodiments may use system-generated relevance rank and user-specified priorities in order to determine the order of display of search results. The system filters out items marked as blocked (priority 1) from display when these items appear in search results. Items marked as Preferred (Priority 4) may be shown at the top during display of search results when such items are part of the search results.

In case the search results do not have user-specified priorities, or when the assigned priority of a search result is 2 or 3, then procurement system 120 may execute software processes to determine the order of display of search results by computing a relevance rank. The relevance rank is an indication of the extent to which the search results match the search term. For example, if the search result starts with the search term in its entirety, then the relevance rank would be 1.0; if the search result does not start with the search term but contains it somewhere in the description, then the relevance rank would be 0.75 and so on. In certain embodiments, if an item has an assigned priority of 2 or 3, the item may be listed ahead of items with the same relevance rank without an assigned priority. Other types of information may be used to reflect ranking values, such as non-numeric information.

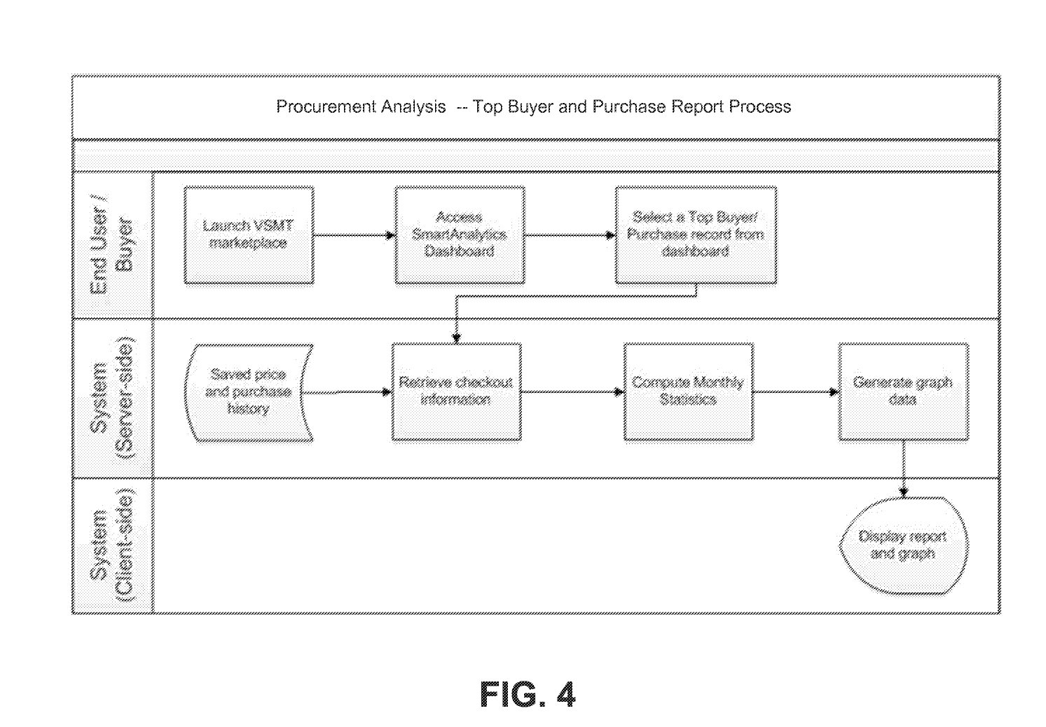

FIG. 4 is a flow diagram illustrating an exemplary purchase report process, consistent with disclosed embodiments. As shown, and in one example, “End User/Buyer” reflects processes performed by a user (e.g., buyer 114), “System (Server-side)” reflects processes performed by procurement system 120, and “System (client-side)” reflects processes performed by client 110 (e.g., web browser 113). Disclosed embodiments may track the purchase (checkout or return of shopping cart from an electronic marketplace to user's electronic procurement system) made by end users and allow users to review the top purchase and top buyer information.

Software executed by a processor, such as processor 122 may perform the report process to generate information to provide different types of reports. For example, a top purchase report shows the item most frequently checked out by the user along with details on the average, highest, least and most recent purchase price, monthly purchase volume, monthly purchase value along with the details on when the item was checked out and by which user.

A top buyer report shows the end user with highest purchase value among all users of the procurement analysis application in the buyer's organization. Details include the items that were checked out along with the date/time of checkout, checkout price and so on. The top purchase and buyer reports are not restricted to any particular rank. The users can review the report of any top purchase/buyer report of any rank.

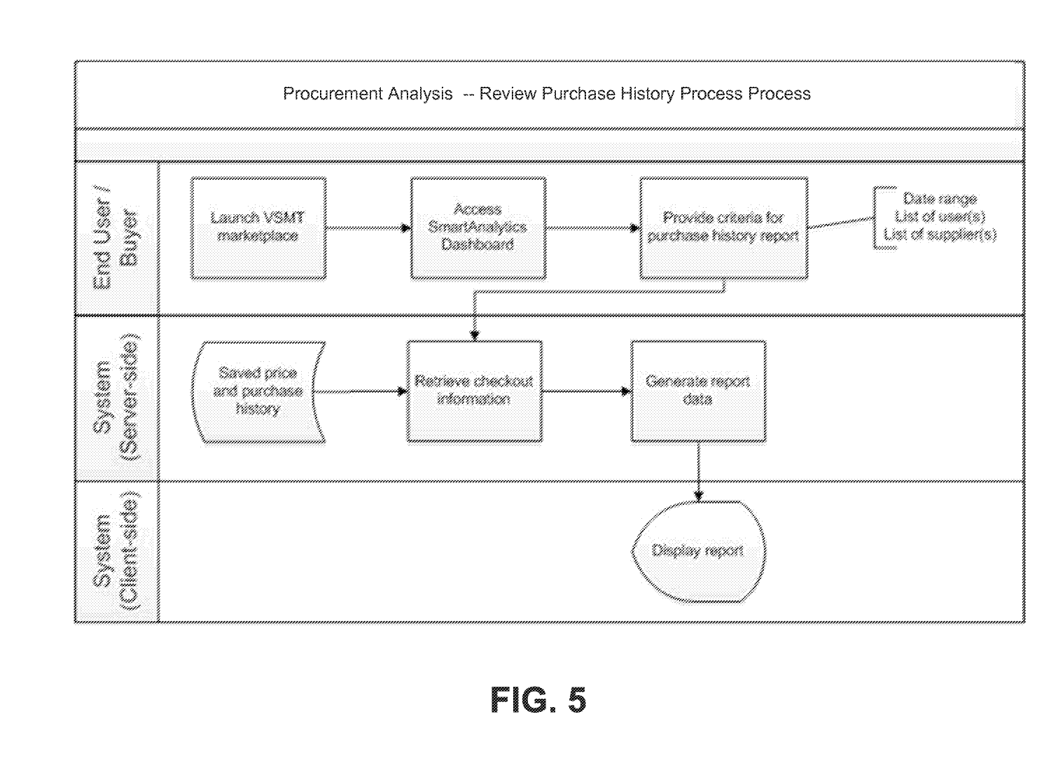

FIG. 5 is a flow diagram illustrating an exemplary purchase history process, consistent with disclosed embodiments. As shown, and in one example, “End User/Buyer” reflects processes performed by a user (e.g., buyer 114), “System (Server-side)” reflects processes performed by procurement system 120, and “System (client-side)” reflects processes performed by client 110 (e.g., web browser). In one embodiment, the user (e.g. buyer) can review the purchase activity of users belonging to the user's organization, not necessarily a top purchase. The user can utilize a report that allows the user to specify the time period, user(s), and/or supplier(s) based on which the purchase history report is generated for viewing and/or exporting in spreadsheet format or other type of document format.

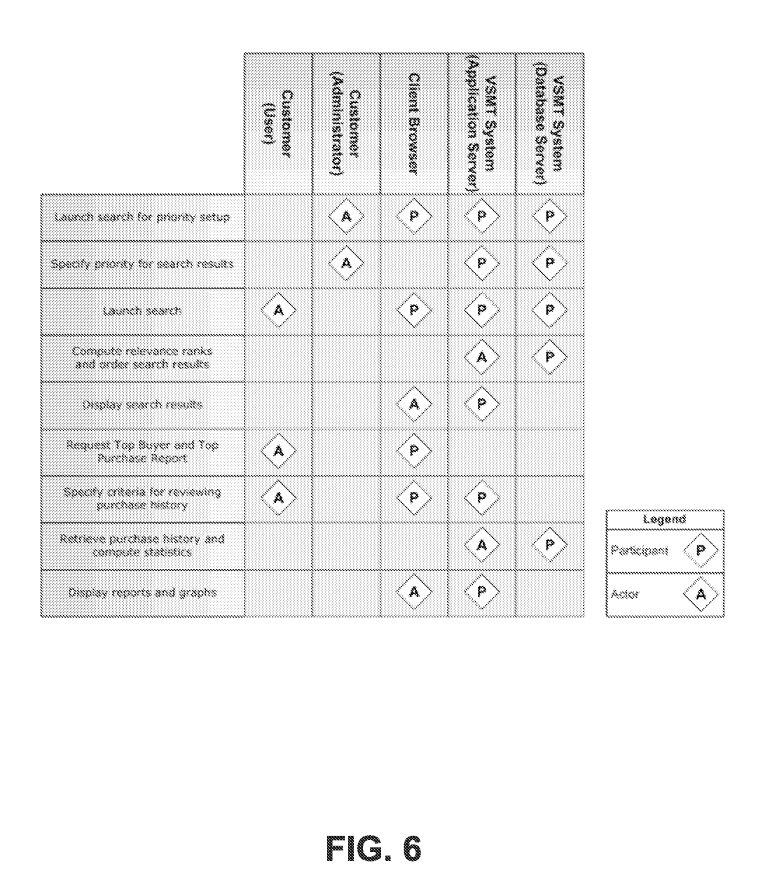

FIG. 6 is an exemplary function and component responsibility matrix, consistent with disclosed embodiments. In one aspect, the first column of the chart in FIG. 6 reflects processes that may be performed by certain entities, users, or components, such as those listed in the first row (e.g., Customer (User), Customer (Administrator), Client Browser, (Application Server), and (Database Server). These entities, users, or components may be an “Actor” or a “Participant” in the disclosed processes. In one embodiment, an ‘Actor’ may be responsible in initiating and/or executing a function by selecting, computing, manipulating, rendering or otherwise triggering the functionality. A ‘Participant’ may participate in a function or process by, for example, providing support to the actor by storing or retrieving data, transmitting information or otherwise acting as a medium or helper in executing the functionality. As shown, and in one example, an “Customer (User)” reflects a user (e.g., buyer 114), “Customer/Administrator” reflects an administrator user associated with a purchasing entity (e.g., purchaser 101), “Client Browser” reflects software (and associated hardware that executes the software) that may be executed by client 110, “Application Server” is a processor associated with procurement system 120, and “Database Server” is a processor associated with data repository 130 (that may be included with procurement system 120).

FIG. 6 maps the various functions associated with one or more disclosed embodiments to exemplary actors that may be responsible for carrying out the function. In one aspect, the first column of the chart in FIG. 6 reflects processes that may be performed by certain entities, users, or components, such as those listed in the first row (e.g., Customer (User), Customer (Administrator), Client Browser, (Application Server), and (Database Server). These entities, users, or components may be an “Actor” or a “Participant” in the disclosed processes. In one embodiment, an ‘Actor’ may be responsible in initiating and/or executing a function by selecting, computing, manipulating, rendering or otherwise triggering the functionality. A ‘Participant’ may participate in a function or process by, for example, providing support to the actor by storing or retrieving data, transmitting information or otherwise acting as a medium or helper in executing the functionality. As shown, and in one example, an “Customer (User)” reflects a user (e.g., buyer 114), “Customer/Administrator” reflects an administrator user associated with a purchasing entity (e.g., purchaser 101), “Client Browser” reflects software (and associated hardware that executes the software) that may be executed by client 110, “Application Server” is a processor associated with procurement system 120, and “Database Server” is a processor associated with data repository 130 (that may be included with procurement system 120).

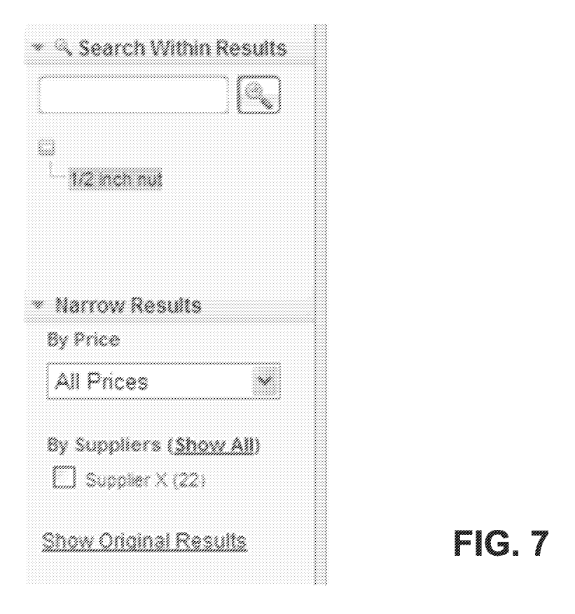

An example of a process for assigning and using priorities in an electronic procurement system consistent with certain disclosed embodiments is disclosed in connection with FIGS. 7-14. The interfaces shown in FIGS. 7-14 are exemplary and not intended to be limiting to the disclosed embodiments. The format, look and feel, configuration, etc. of the interfaces shown in FIGS. 7-14 may be different without departing from the spirit and scope of the disclosed embodiments. In one embodiment, procurement system 120 executes software processes to generate information used in the exemplary interfaces shown in FIGS. 7-14. Moreover, procurement system 120 may execute software that generates the content and interfaces for display to a user.

In one example, an individual in an organization (e.g., buyer 114) may request a search for a ½ inch nut from the catalog of Supplier X by inputting the search to procurement system 120. Procurement system 120 may cause a search of data associated with Supplier X's catalog, resulting in 22 search results (catalog items). FIG. 7 shows a diagram of an exemplary interface of summary data for the search results of the individual's exemplary search.

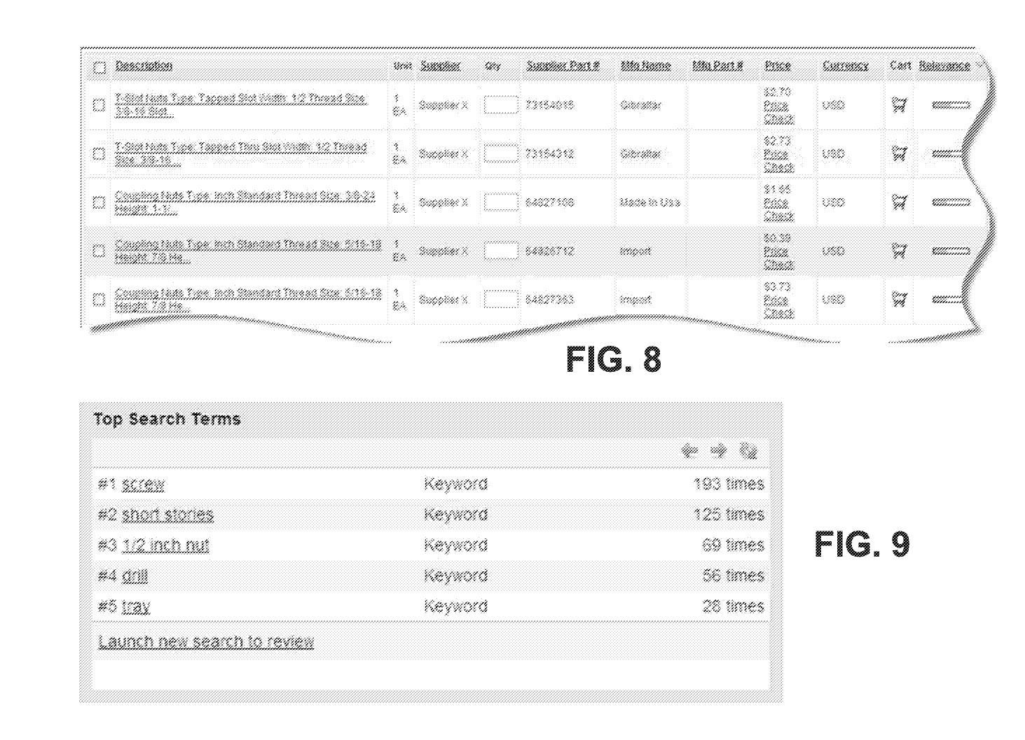

FIG. 8 shows an exemplary interface showing of a complete search result listing for the same search. In one aspect, the items shown in FIG. 8 may be presented by a processor based on an internal relevance order because none of the items have a priority associated with them.

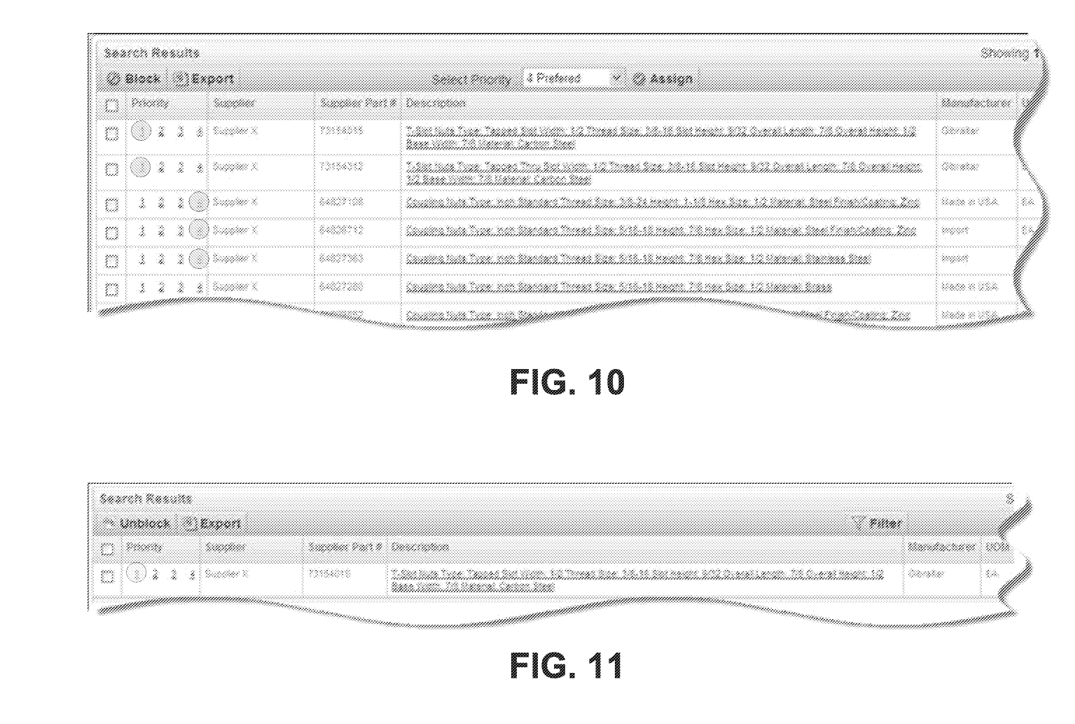

In one embodiment, an administrator (or other user) in the organization may decide to assign priorities to some catalog items. In one example, procurement system 120 may generate data to display data like that shown in FIG. 9. In this aspect, the procurement system 120 may determine information used in an interface that allows a user to select the “½ inch nut” search performed by the individual. For example, the administrator may choose search #3 by clicking on the link “½ inch nut.” Procurement system 120 may also generate information used in an interface, such as the one shown in FIG. 10, in response to selection of search #3. The administrator may use the interface of FIG. 10 to select a priority for items returned in the search result. For example, the administrator may choose to block T-slot nuts (or limit its preference for display) by selecting priority 1, as indicated by the circles in FIG. 10. The administrator may choose to make Coupling Nuts preferred by selecting priority 4, also indicated by the circles in FIG. 10. In response to these selections, procurement system 120 may save the priority associated with each catalog item so that the priority may be used to adjust future search results. The blocked t-slot nuts may show up as blocked in an interface similar to FIG. 11. Procurement system 120 may be configured to generate information for the exemplary interface of FIG. 11. Procurement system 120 may also generate information to allow a user to unblock catalog items. In one embodiment, procurement system 120 may generate an interface such as FIG. 11 that may be used by an administrator to unblock catalog items.

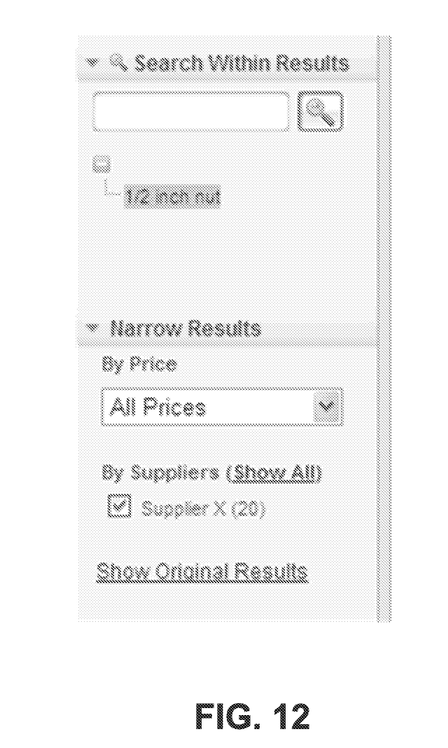

After procurement system 120 receives the priority assignments from a user or program, it may save the information in memory. Consistent with disclosed embodiments, other values or representations may be implemented to assign priorities or block selected items or server data. For example, procurement system 120 may be configured to provide color codes, text, alpha-numeric values etc. that can be used by a user or program to assign priorities. In one aspect, a user may perform a subsequent search for “½ inch nuts”, which may result in procurement system 120 generating an interface similar to that illustrated in FIG. 12. Procurement system 120 may be configured to perform search and analysis processes such that results are generated and rendered in an interface that provides filtered results. In this example, because T-slot nuts have been assigned a “block” priority, the search returns 20 items instead of 22.

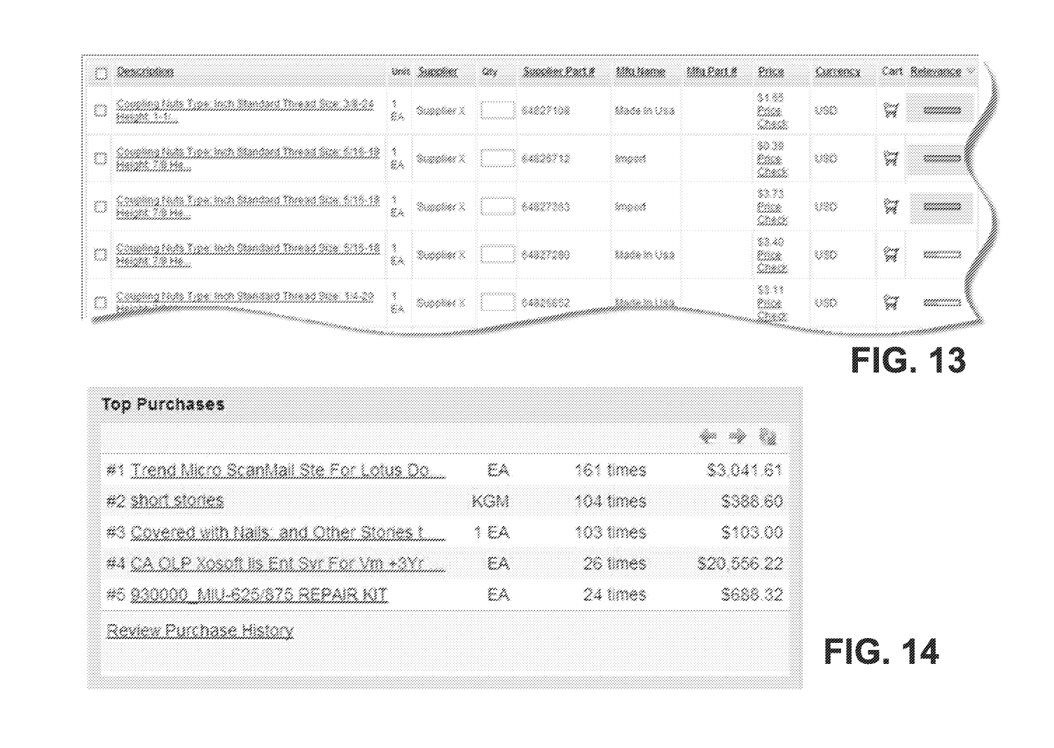

Following this example, procurement system 120 may generate information used in an interface such as that shown in FIG. 13. FIG. 13 shows an exemplary interface reflecting that the T-slot nuts are no longer part of the search result detail listing. Furthermore, the coupling nuts assigned a priority of 4 now show as 100% relevant in the interface of FIG. 13, which differs from the relevance previously shown in FIG. 8. As such, certain embodiments procurement system 120 (via software executed by a processor) to change the relevance of subsequent searches (e.g., from the same procurement server) for items in an electronic catalog based on assigned priorities by other users or processes.

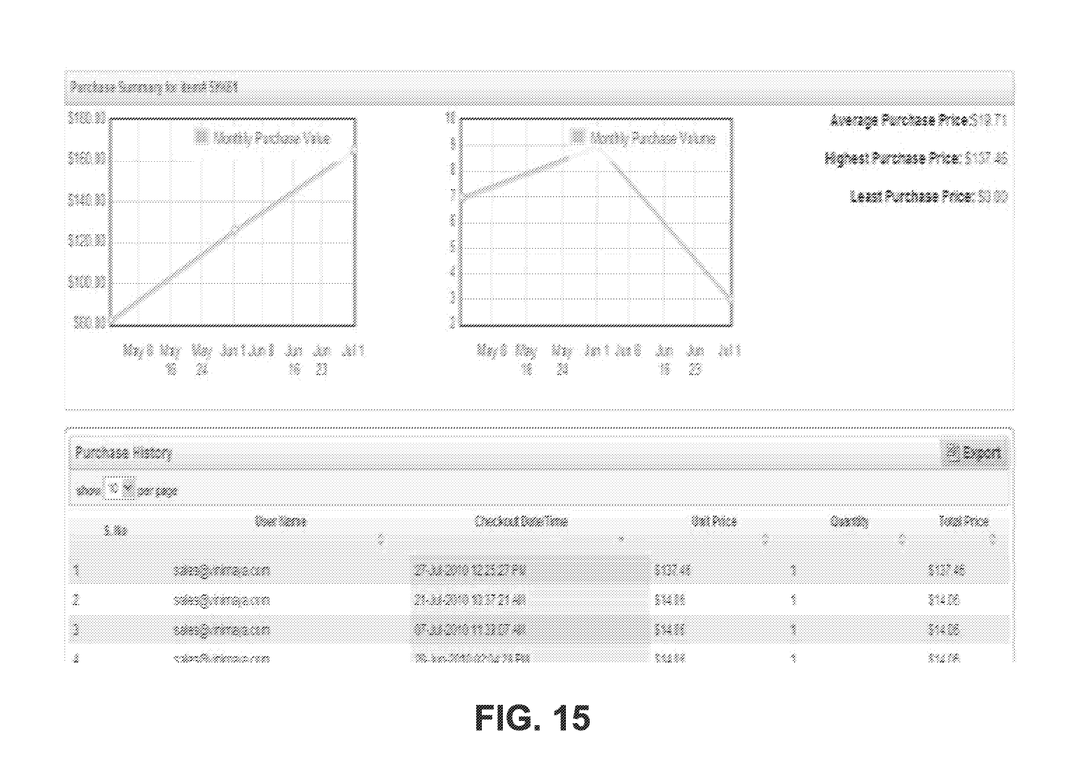

In certain embodiments, procurement system 120 may generate information reflecting top selling items for presentation in various interfaces. For example, FIG. 14 shows an interface that includes information reflecting top selling items that may be rendered on a display device based on information generated by procurement system 120. A user may select one of the top selling items, and in a response to the selection, procurement system 120 may generate data used to display a detailed monthly report, such as the report shown in FIG. 15. The report of FIG. 15 may show the monthly purchase volume, value, and the checkout history of purchased items.

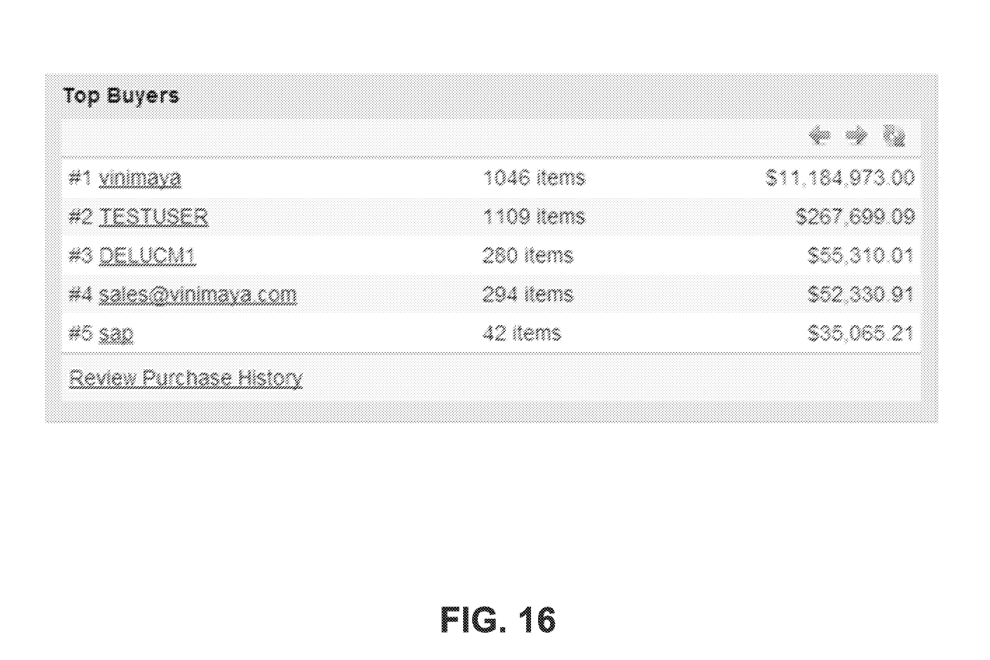

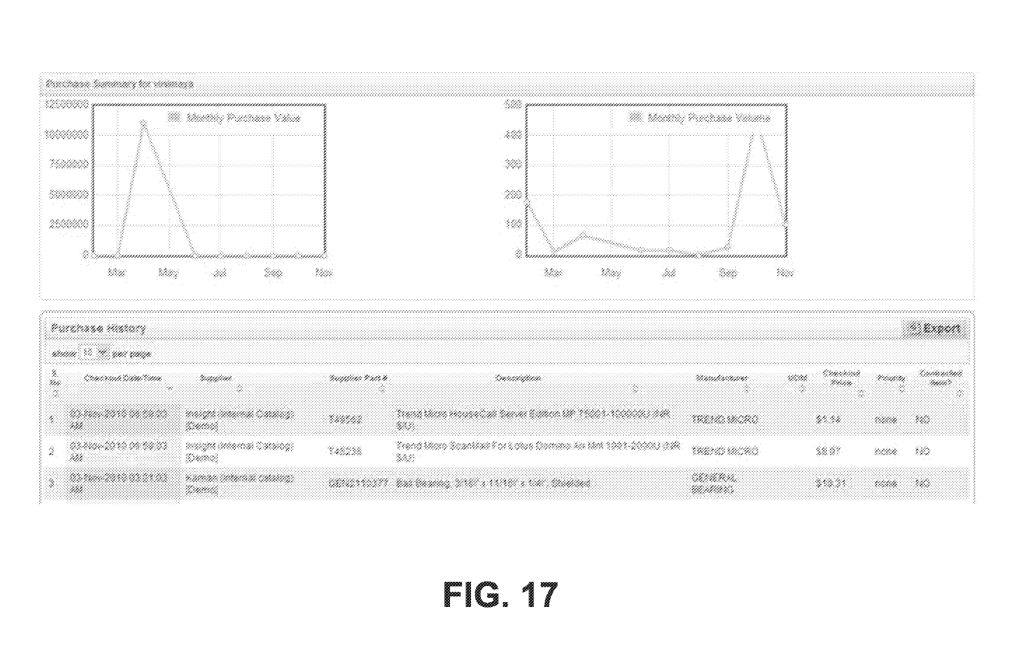

In one embodiment, procurement system 120 may be configured to generate reports reflecting top buyers of items. FIG. 16 shows an exemplary report that can be generated based on information collected, analyzed, processed, etc. by procurement system 120. Further, in one embodiment, in response to selection of one of the top buyers, procurement system 120 may create a detailed monthly report, such as the report shown in FIG. 17. The report shown in FIG. 17 may include information reflecting the monthly purchase volume, value, and the checkout history of one or more buyers.

The data included in the disclosed reports may be generated by software processes executed by a processor, such as processor 122. Each process may analyze, request, search, or retrieve data from a memory (e.g., storage 121 and/pr database 131), parse or filter the data, and generate information used to display the data in a user interface, such as a display associated with client 110 and viewed by buyer 114, or another person such as an administrator accessing the data using another computer system.

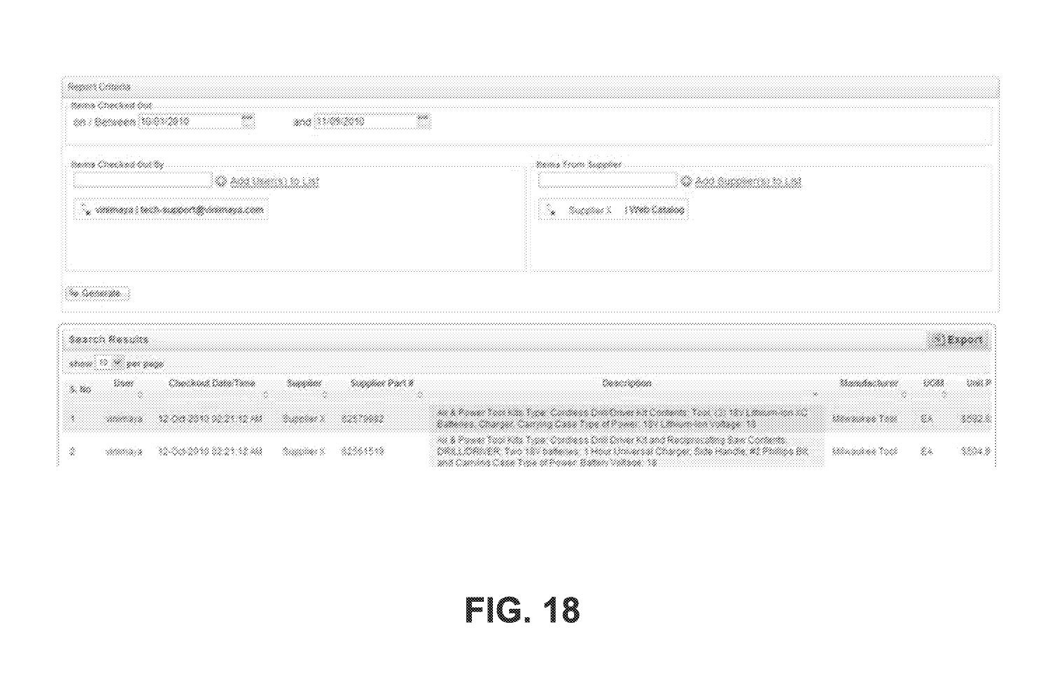

Procurement system 120 may also be configured to provide custom reports. For example, procurement system 120 may execute software that enable users to create custom reports based on purchase (checkout) history. FIG. 18 shows an exemplary custom report consistent with disclosed embodiments. Software executed by a processor in procurement system 120 will receive input from a user to combine one or more parameters for generating the custom report. The disclosed system may, based on the user selections, generate a custom report that can be displayed on a user interface of a computer system.

The foregoing descriptions have been presented for purposes of illustration and description. They are not exhaustive and do not limit the disclosed embodiments to the precise form disclosed. Modifications and variations are possible in light of the above teachings or may be acquired from practicing the disclosed embodiments. For example, the described implementation includes software, but the disclosed embodiments may be implemented as a combination of hardware and software. Additionally, although disclosed aspects are described as being stored in a memory on a computer, one skilled in the art will appreciate that these aspects can also be stored on other types of tangible computer-readable media, such as secondary storage devices, like hard disks, floppy disks, a CD-ROM, or other forms of RAM or ROM.

Computer programs based on the written description and disclosed methods are within the capabilities of one of ordinary skill in the art. The various programs or program modules can be created using any of the techniques known to one skilled in the art or can be designed in connection with existing software, or any other now known or later created programming language. One or more of such software sections or modules can be integrated into a computer system or existing browser software.

Other embodiments will be apparent to those skilled in the art from consideration of the specification and practice of the embodiments disclosed herein. The recitations in the claims are to be interpreted broadly based on the language employed in the claims and not limited to examples described in the present specification or during the prosecution of the application, which examples are to be construed non-exclusive. Further, the steps of the disclosed methods may be modified in any manner, including by reordering steps and/or inserting or deleting steps. It is intended, therefore, that the specification and examples be considered as exemplary only, with a true scope and spirit being indicated by the following claims and their full scope equivalents.

In certain embodiments, procurement system 120 may execute software that generates the information that is reflected in the exemplary user interfaces described above. In this regard, procurement system 120 performs processes via the executed software that analyzes data from data storage devices and received from users to generate results and content that is provided to the end-user's computer for display on a display device. In certain embodiments, information that is normally provided by a user may be generated by procurement system 120. For example, procurement system 120 may be configured to generate priority rankings for items that are applied to filter search results, as described above. For example, procurement system 120 may be configured to generate priority rankings based on predetermined ranking data, promotion data, or terms relating to a contract that are stored in a memory and evaluated by processes executed by processor 122.

What is claimed is:

1. An electronic procurement system comprising:
a processor; and
a memory coupled to the processor, the memory storing instructions to direct the processor to perform operations comprising:
receiving a search request;
searching electronic supplier catalogs to generate a plurality of items based on the search request, wherein the electronic supplier catalogs are remote from the electronic procurement system;
receiving priority rankings for at least one item of the plurality of items;
generating search results based on the plurality of items;
filtering the search results based on the priority rankings; and
providing the filtered search results for display to a user.

2. The electronic procurement system of claim 1, wherein the priority rankings are provided by the user or a second user different from the user.

3. The electronic procurement system of claim 2, the memory further storing instructions to direct the processor to perform operations comprising:
exporting the search results to the user with an instruction to identify priority rankings for the search results;
importing the priority rankings from the user; and
storing the priority rankings.

4. The electronic procurement system of claim 1, wherein filtering the search results further includes removing items having a priority ranking at or below a predetermined threshold from the search results.

5. The electronic procurement system of claim 1, wherein the priority rankings are based on at least one of user specified ranks, promotions, or contract terms.

6. The electronic procurement system of claim 1, wherein the priority ranking includes a value on a pre-defined scale that indicates at least one of relevance of the search result to the search request or relevance of the search result to a contract of a buying organization with a supplier.

7. The electronic procurement system of claim 1, wherein the search request includes at least one of a search term, a search type, or a supplier identifier.

8. The electronic procurement system of claim 1, the memory further storing instructions to direct the processor to perform operations comprising:
receiving a plurality of search requests;
searching the at least one supplier catalog to generate the plurality of items based on the plurality of search requests;
exporting the search results to the user with an instruction to identify priority rankings for the search results;
receiving priority rankings identified by the user; and
storing the priority rankings,
wherein the step of receiving priority rankings includes receiving the stored priority rankings.

9. The electronic procurement system of claim 1, the memory further storing instructions to direct the processor to perform operations comprising:
generating search history data including information relating to at least one of:
the identity of one or more users who search for specified products from specified one or more suppliers,
how many results are obtained from specified one or more supplier catalogs, and
an identity of general categories of items that have been searched; and
providing the search history data to the user.

10. The electronic procurement system of claim 1, the memory further storing instructions to direct the processor to perform operations comprising:
generating at least one of a purchase report or a buyer report,
the purchase report including information about a purchased item purchased by a selected user, the information including at least one of an average purchase price, a highest purchase price, a lowest purchase price, a most recent purchase price, a monthly purchase volume, a monthly purchase value, or a most recent purchase date, and
the buyer report including information about a buyer within an organization, the information including items purchased by the buyer along with at least one of a date and time of purchase, a purchase price, or a purchase volume; and
providing the at least one of the purchase report or the buyer report to the user.

11. The electronic procurement system of claim 10, wherein the at least one of the purchase report or the buyer report is at least one of a top purchase report or a top buyer report,
the top purchase report including information about an item most frequently purchased by the selected user,
the top buyer report including information about a buyer with a highest purchase value among other buyers that are associated with using the procurement system within the organization.

12. A computer-implemented method for influencing a search result in an electronic catalog, comprising:
Receiving, by a processor, a search request;
searching, by the processor, at least one electronic supplier catalog to generate a plurality of items based on the search request, wherein the at least one electronic supplier catalog is accessed over a network;
receiving priority rankings for at least one item of the plurality of items;
generating, by the processor, search results based on the plurality of items;
filtering, by the processor, the search results based on the priority rankings; and
providing, by the processor, the filtered search results for display to a user.

13. The method of claim 12, further comprising:
exporting the search results to the user with an instruction to identify priority rankings for the search results;
importing the priority rankings from the user; and
storing the priority rankings.

14. The method of claim 12, further comprising:
receiving a plurality of search requests;
searching, by the processor, the at least one seller catalog to generate the plurality of items based on the plurality of search requests;
exporting the search results to the user with an instruction to identify priority rankings for the search results;
importing the priority rankings from the user; and
storing the priority rankings;
wherein the step of receiving priority rankings includes receiving the stored priority rankings.

15. The method of claim 12, further comprising:
storing search history data including information relating to at least one of:
the identity of one or more users who search for specified products from specified one or more suppliers,
how many results are obtained from specified one or more supplier catalogs, and an identity of general categories of items that have been searched; and
providing the search history data to the user.

16. The method of claim 12, further comprising:
generating at least one of a purchase report or a buyer report,
the purchase report including information about a purchased item purchased by a selected user, the information including at least one of an average purchase price, a highest purchase price, a lowest purchase price, a most recent purchase price, a monthly purchase volume, a monthly purchase value, or a most recent purchase date, and
the buyer report including information about a buyer within an organization, the information including items purchased by the buyer along with at least one of a date and time of purchase, a purchase price, or a purchase volume; and
providing the at least one of the purchase report or the buyer report to the user.

17. The method of claim 16, wherein the at least one of the purchase report or the buyer report is at least one of a top purchase report or a top buyer report,
the top purchase report including information about an item most frequently purchased by the selected user,
the top buyer report including information about a buyer with a highest purchase value among all buyers using the procurement system within the organization.

18. A non-transitory, tangible computer readable storage medium storing instructions to direct a processor to perform operations comprising:
receiving a search request;
searching over a network at least one electronic supplier catalog to generate a plurality of items based on the search request;
receiving priority rankings for at least one item of the plurality of items;
generating search results based on the plurality of items;
filtering the search results based on the priority rankings; and
providing the filtered search results to a user.

19. The storage medium of claim 18, further storing instructions to direct a processor to perform operations comprising:
receiving a plurality of search requests;
searching the at least one seller catalog to generate the plurality of items based on the plurality of search requests;
exporting the search results to the user with an instruction to identify priority rankings for the search results;
importing the priority rankings from the user; and
storing the priority rankings;
wherein the step of receiving priority rankings includes receiving the stored priority rankings.

20. The storage medium of claim 18, further storing instructions to direct a processor to perform operations comprising:
generating at least one of a purchase report or a buyer report,
the purchase report including information about a purchased item purchased by a selected user, the information including at least one of an average purchase price, a highest purchase price, a lowest purchase price, a most recent purchase price, a monthly purchase volume, a monthly purchase value, or a most recent purchase date, and
the buyer report including information about a buyer within an organization, the information including items purchased by the buyer along with at least one of a date and time of purchase, a purchase price, or a purchase volume; and
providing the at least one of the purchase report or the buyer report to the user.
